(19) United States
(12) Patent Application Publication
(10) Pub. No.: US 2013/0008578 A1
(43) Pub. Date: Jan. 10, 2013

(54) Lighter Than Air Tire and Tube

(76) Inventor: Robbie K. Taylor, Wynne, AR (US)

(21) Appl. No.: 13/178,672

(22) Filed: Jul. 8, 2011

(51) Int. Cl. B60C 5/00

(52) U.S. Cl. 152/450

(57) ABSTRACT

A tire for a vehicle may include a cavity, and the cavity may be filled with a lighter than air gas. The gas may be hot air. The gas may be neon. The gas may be ammonia. The gas may be methane. The tire may include an interior surface having a reflective surface. The tire may include a tire tube having an exterior surface having a reflective surface. The tire may include a tire tube having an interior surface having a reflective surface.

### FIELD OF THE INVENTION

The present invention relates to tires and more particularly to a tire having a reflective interior and filled with helium or other lighter than air materials and having a tube having a reflective interior surface and exterior surface and a tire having a reflective interior surface.

### BACKGROUND

In today's vehicle world, the cost of fuel is a very important consideration when driving. As a general rule, a heavy vehicle generally uses more fuel than a lighter vehicle other factors being the same. If a vehicle could be made lighter, fuel efficiency should increase.

Radiant barriers have been installed in homes-usually in attics-primarily to reduce summer heat gain, which helps lower cooling costs. The barriers consist of a highly reflective material that reflects (or more specifically, re-emits) radiant heat rather than absorbing it.

Heat travels from a warm area to a cool area by a combination of conduction, convection, and radiation. Heat flows by conduction from a hotter location within a material or assembly to a colder location. Heat transfer by convection occurs when a liquid or gas is heated by a surface, becomes less dense, and rises (natural convection), or when a moving stream of air absorbs heat from a warmer surface (forced convection). Radiant heat travels in a straight line away from any surface and heats anything solid that absorbs the incident energy. Radiant heat transfer occurs because warmer surfaces emit more radiation than cooler surfaces.

When the sun heats a roof, it's primarily the sun's radiant energy that makes the roof hot. A large portion of this heat travels by conduction through the roofing materials to the attic side of the roof. The hot roof material then radiates its gained heat energy onto the cooler attic surfaces, including the air ducts and the attic floor. A radiant barrier reduces the radiant heat transfer from the underside of the roof to the other surfaces in the attic.

A radiant barrier's performance is determined by three factors:

Emissivity (or emittance)—the ratio of the radiant energy (heat) leaving (being emitted by) a surface to that of a black body at the same temperature and with the same area. It's expressed as a number a between 0 and 1. The higher the number, the greater the emitted radiation.

Reflectivity (or reflectance)—a measure of how much radiant heat is reflected by a material. It's also expressed as a number between 0 and 1 (sometimes, it is given as a percentage between 0 and 100%). The higher the number, the greater the reflectivity.

The angle the incident radiation strikes the surface-a right angle (perpendicular) usually works best.

All radiant barriers must have a low emissivity (0.1 or less) and high reflectivity (0.9 or more). From one brand of radiant barrier to another, the reflectivity and emissivity are usually so similar that it makes little difference as far as thermal performance. (Most products have emissivities of 0.03-0.05, which generally corresponds to a reflectivity of 95%-97%.) Also, the greater the temperature difference between the sides of the radiant barrier material, the greater the benefits a radiant barrier can offer.

Radiant barriers are more effective in hot climates than in cool climates, especially when cooling air ducts are located in the attic. Some studies show that radiant barriers can lower cooling costs between 5%-10% when used in a warm, sunny climate. The reduced heat gain may even allow for a smaller air conditioning system. But in cool climates, it's usually more cost effective to install more than the minimum recommended level of insulation rather than a radiant barrier.

Radiant barriers come in a variety of forms, including reflective foil, reflective metal roof shingles, reflective laminated roof sheathing, and even reflective chips, which can be applied over loose-fill insulation. The reflective material, usually aluminum, is applied to one or both sides of a number of substrate materials. Substrate materials include kraft paper, plastic films, cardboard, oriented strand board, and air infiltration barrier material. Some products are fiber-reinforced to increase the durability and ease of handling.

Also, radiant barriers-which don't provide a significant amount of thermal insulation-can be combined with many types of insulation materials. These combinations are called reflective insulation systems. In these combinations, radiant barriers can also act as the insulation's facing material.

U.S. Pat. No. 6,522,980 discloses a method and algorithm for predicting the fluid loss rate of a system, using data for the leak rate from the system for a substitute fluid that leaks at a different rate than the system fluid. In the illustrated embodiment, the system is a pneumatic tire and the substitute fluid is helium gas. The helium leak rate data is used in a Fortran program to predict the air loss rate from the tire by determining the leak rate factor f for helium, as compared to air, and using T to calculate the air loss rate.

U.S. Pat. No. 6,330,822 discloses a tire testing apparatus and method for detecting leaks in tires used on lawn mowers. The tire testing apparatus includes a vacuum chamber, a roughing pump, a hi-vac pump, an airtight seal, and a spectrometer. The roughing pump and hi-vac pump evacuate the air from the vacuum chamber, creating a vacuum. The pressure sensor detects the level of vacuum in the vacuum chamber and reports this information to the PLC. A method of detecting leaks in tires using the tire testing apparatus is also provided. The method includes the steps of inflating the tire with a mixture of air and 10% helium by volume, placing the tire in the vacuum chamber, sealing the vacuum chamber and removing the air creating a vacuum, then detecting the amount of helium in the chamber, and removing the tire from the chamber and placing it either in the rejected conveyor, or the acceptable conveyor.

### SUMMARY

A tire for a vehicle may include a cavity, and the cavity may be filled with a lighter than air gas.

The gas may be hot air.

The gas may be neon.

The gas may be ammonia.

The gas may be methane.

The tire may include an interior surface having a reflective surface.

The tire may include a tire tube having an exterior surface having a reflective surface.

The tire may include a tire tube having an interior surface having a reflective surface.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the tire of the present invention;

FIG. 2 illustrates an end view of the tire of the present invention;

FIG. 3 illustrates a side view of a tube of the tire of the present invention;

FIG. 4 illustrates an end view of the tube of the tire of the present invention;

FIG. 5 illustrates a cross-sectional view of the tube of the tire and the tire of the present invention.

### DETAILED DESCRIPTION

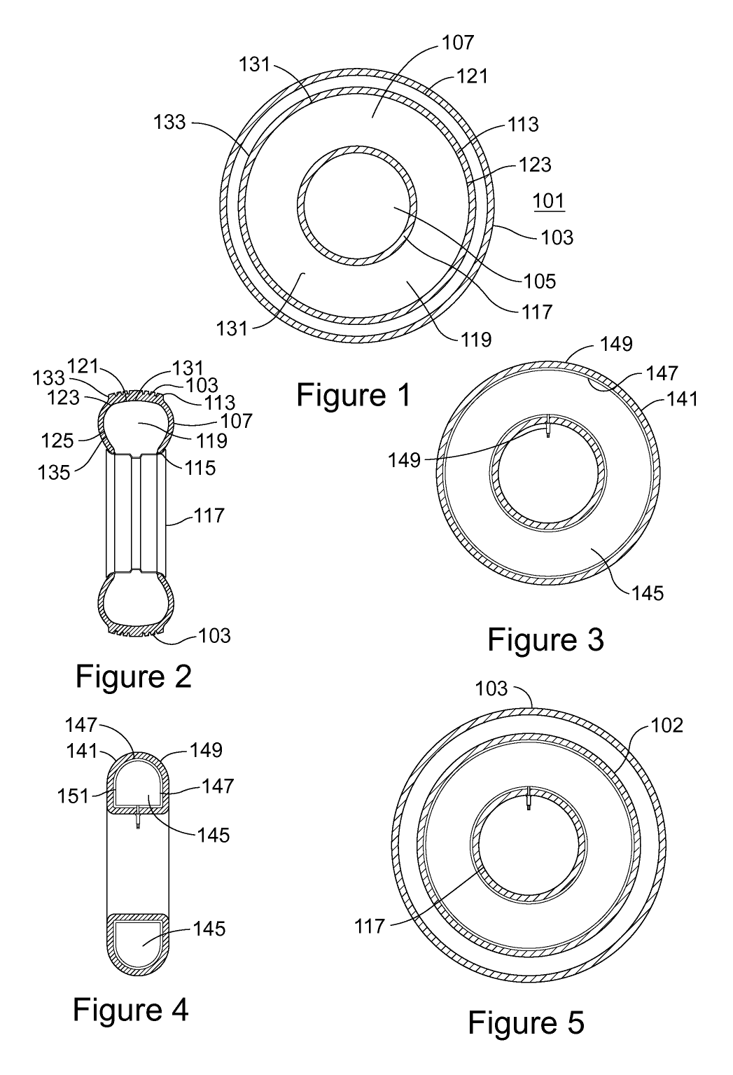

FIG. 1 illustrates a cross-sectional side view of the tire 101 which may include a tire tread exterior surface 103 which may extend around the periphery of the tire 101 and which may be connected to a tire shoulder 113 which may be connected to the tire tread exterior surface 103. The tire 101 may be substantially doughnut shaped, formed from a flexible material and hollow Additionally, the tire shoulder 113 may be connected to a tire sidewall surface 107 around the periphery of the tire 101, and the tire sidewall surface 107 may extend radially and connect to a tire bead 115 which may define a central aperture 105 which may cooperate with a tire wheel 117 which may form a seal with the tire bead 115 in order that the hollow cavity 119 of the tire 101 which may be defined by the tire tread interior surface 121 which may be opposed to the tire tread exterior surface 103, the tire shoulder interior surface 123 which may be opposed to the tire shoulder exterior surface 113, the interior tire sidewall surface 125 which may be opposed to the exterior tire size sidewall surface 109 and the exterior surface of the tire wheel 117.

The tire tread interior surface 121 may be connected to the tire shoulder interior surface 103 which may be connected to the interior tire sidewall surface 125.

The tire tread interior surface 121 may be coated with a tire tread interior reflective surface 131 which may include a reflective material as described below; the tire shoulder interior surface 103 may be coated with a tire shoulder interior reflective surface 133 which may include a reflective material as described below, and the interior tire sidewall surface 125 may be coated with a tire sidewall reflective surface 135. The reflective material may be placed on the hub of the automobile and/or the rim.

FIG. 2 illustrates a cross-sectional end view of the tire 101 which may include a tire tread exterior surface 103 which may extend around the periphery of the tire 101 and which may be connected to a tire shoulder exterior surface 113 which may be connected to the tire tread exterior surface 103. The tire 101 may be substantially doughnut shaped, formed from a flexible material and hollow Additionally, the tire shoulder 113 may be connected to a exterior tire sidewall surface 107 around the periphery of the tire 101, and the exterior tire sidewall surface 107 may extend radially and connect to a tire bead 115 which may define a central aperture 105 which may cooperate with a tire wheel 117 which may form a seal with the tire bead 115 in order that the hollow cavity 119 of the tire 101 which may be defined by the tire tread interior surface 121 which may be opposed to the tire tread exterior surface 103, the tire shoulder interior surface 123 which may be opposed to the tire shoulder exterior surface 113, the interior tire sidewall surface 125 which may be opposed to the exterior tire size sidewall surface 109 and the exterior surface of the tire wheel 117.

The tire tread interior surface 121 may be connected to the tire shoulder interior surface 103 which may be connected to the interior tire sidewall surface 125.

The tire tread interior surface 121 may be coated with a tire tread interior reflective surface 131 which may include a reflective material as described below; the tire shoulder interior surface 103 may be coated with a tire shoulder interior reflective surface 133 which may include a reflective material as described below, and the interior tire sidewall surface 125 may be coated with a tire sidewall reflective surface 135.

FIG. 3 illustrates a side view of the tire tube 102 which may be substantially doughnut shaped and which may cooperate with the tire 101. The tire tube 102 may include an exterior tube surface 141 and interior tube surface 143 which may define a tube hollow cavity 145. The hollow tube cavity 145 may be defined by interior tube surface 147 which may be opposed to the exterior tube surface 141. The exterior tube surface 141 may be coated with an exterior reflective tube surface 149, and the interior tube surface 143 may be coated with interior reflective tube surface 151. The exterior reflective surface 149 and the interior reflective tube surface 151 may be formed from reflective material as described below.

FIG. 4 illustrates an end view of the tire tube 102 which may be substantially doughnut shaped and which may cooperate with the tire 101. The tire tube 102 may include an exterior tube surface 141 and interior tube surface 143 which may define a tube hollow cavity 145. The hollow tube cavity 145 may be defined by interior tube surface 147 which may be opposed to the exterior tube surface 141. The exterior tube surface 141 may be coated with an exterior reflective tube surface 149, and the interior tube surface 143 may be coated with interior reflective tube surface 151. The exterior reflective surface 149 and the interior reflective tube surface 151 may be formed from reflective material as described below.

FIG. 5 illustrates the tube 102 positioned within the tire 103 and mounted on the wheel 117.

The reflective coating may be used to reflect heat away from the tire 103 and the tube 102 and may be a spray-on radiant heat barrier which may be essentially a “liquid foil” in the form of a paint. The reflective coating may substantially cover the entire interior surface of the tire 103, may substantially cover the entire exterior surface of the tube 102 and may substantially cover the entire interior surface of the tube 102. The reflective coating may be a film or alternatively, the reflective coating may be a foil for the heat barrier. There are many brands of paint and have different performance characteristics. The best are water-based low-e paint called HeatBloc-75 made by STS Coatings or Radiance e.25, made by BASF.

The reflective coating in the form of a radiant barrier spray paint may be sprayed on, applied in sheets by epoxy or other methods of application.

The tire 103 may be tubeless, and the tire 103 may be a tube tire with the tube 102. The tire 103 or the tube 102 may be filled with a lighter than air gas either solely filled or partially filled with the lighter than air gas. Neon may be used as the lighter than air gas and has been shown to lift a balloon.

Water Vapor may be used as the lighter than air gas. An the gaseous state, water is lighter than air and has successfully been used as a lifting gas. Ammonia may be used as the lighter than air gas, and ammonia has sometimes been used to fill weather balloons. Due to its relatively high boiling point (compared to helium and hydrogen), ammonia could potentially be refrigerated and liquefied prior to being placed in the tire 103 and returned to a gas when introduced to the tire 103.

Methane may be used as the lighter than air gas which is the chief component of natural gas is sometimes used as a lift gas when hydrogen and helium are not available. Methane has the advantage of not leaking through tire walls as rapidly as the small-molecule hydrogen and helium.

Hydrogen, helium hydrogen mixture may be used as the lighter than air gas.

Although helium is twice as heavy as (diatomic) hydrogen, they are both so much lighter than air that this difference is inconsequential. Hydrogen has about 8% more buoyancy than helium.

Nitrogen gas may be used as a lighter than air gas. Aerogel may be used as an equivalent of the lighter than air gas, but it is one of the lightest solids or to be more accurate the least dense solid. Aerogel is mostly air because it's structure is like that of a highly vacuous sponge. SEAgel, in the same family as aerogel but made from agar, can be filled with nitrogen gas to create a solid which floats or hangs in the air.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A tire for a vehicle, comprising:
the tire including a cavity;
wherein the cavity is filled with a lighter than air gas.

2. A tire for a vehicle as in claim 1, wherein the gas is hot air.

3. A tire for a vehicle as in claim 1, wherein the gas is neon.

4. A tire for a vehicle as in claim 1, wherein the gas is ammonia.

5. A tire for a vehicle as in claim 1, wherein the gas is methane.

6. A tire for a vehicle as in claim 1, wherein the tire includes an interior surface having a reflective surface.

7. A tire for a vehicle as in claim 1, wherein the tire includes a tire tube having an exterior surface having a reflective surface.

8. A tire for a vehicle as in claim 1, wherein the tire includes a tire tube having an interior surface having a reflective surface.
